(19) United States
(12) Patent Application Publication
(10) Pub. No.: US 2011/0213610 A1
(43) Pub. Date: Sep. 1, 2011

(54) Processor Implemented Systems and Methods for Measuring Syntactic Complexity on Spontaneous Non-Native Speech Data by Using Structural Event Detection

(76) Inventors: Lei Chen, Lawrenceville, NJ (US); Joel Tetreault, Lawrenceville, NJ (US); Xiaoming Xi, Pennington, NJ (US); Klaus Zechner, Princeton, NJ (US); Miao Chen, Bloomington, IN (US); Su-Youn Yoon, Lawrenceville, NJ (US)

(21) Appl. No.: 13/035,428

(22) Filed: Feb. 25, 2011

Related U.S. Application Data
(60) Provisional application No. 61/309,233, filed on Mar. 1, 2010.
(60) Provisional application No. 61/372,964, filed on Aug. 12, 2010.

(51) Int. Cl. G06F 17/27

(52) U.S. Cl. 704/9; 704/E11.001

(57) ABSTRACT

Systems and methods are provided for providing a score for a spontaneous non-native speech response to a prompt. A transcription of the spontaneous speech response is accessed. A plurality of clauses are identified within the spontaneous speech response, where identifying a clause includes identifying a beginning boundary and an end boundary of the clause in the spontaneous speech response. A plurality of disfluencies in the spontaneous speech response is identified. One or more proficiency metrics are calculated based on the plurality of identified clauses and the plurality of the identified disfluencies, and a score for the spontaneous speech response is generated based on the one or more proficiency metrics.

### CROSS-REFERENCE TO RELATED APPLICATIONS

This application claims priority to U.S. Provisional Patent Application No. 61/309,233, filed Mar. 1, 2010, entitled “Processor Implemented Systems and Methods for Measuring Syntactic Complexity Using Structural Events on Non-Native Spoken Data,” and to U.S. Provisional Patent Application No. 61/372,964, filed Aug. 12, 2010, entitled “Computing and Evaluating Syntactic Complexity Features for Spontaneous Speech of Non-Native Test Takers.” The entirety these applications is herein incorporated by reference.

### FIELD

The technology described herein relates generally to speech scoring and more particularly to using structural events to score spontaneous speech responses.

### BACKGROUND

In the last decade, research work has begun on automatic estimation of structural events (e.g., clause and sentence structure, disfluencies, and discourse markers) on spontaneous speech. Structural events have been used in natural language processing (NLP) applications, including parsing speech transcriptions, information retrieval (IE), machine translation, and extractive speech summarization.

However, the structural events in speech data have not been utilized in using automatic speech recognition (ASR) technology to assess speech proficiency. This type of ASR analysis has traditionally used cues derived at the word level, such as a temporal profile of spoken words. The information beyond the word level (e.g., clause/sentence structure of utterances and disfluency structure) has not been used to its full potential.

### SUMMARY

Systems and methods are provided for providing a score for a spontaneous speech response to a prompt. A transcription of the spontaneous speech response may be accessed. A plurality of clauses may be identified within the spontaneous speech response, where identifying a clause includes identifying a beginning boundary and an end boundary of the clause in the spontaneous speech response. The term “clause” encompasses different types of word groupings that represent a complete idea, including “sentences” and “T-Units”

A plurality of disfluencies in the spontaneous speech response may be identified. Furthermore, a plurality of syntactic structures may be identified within each clause. One or more proficiency metrics may be calculated based on the plurality of identified clauses, the identified disfluencies, and the identified syntactic structures and a score for the spontaneous speech response may be generated based on the one or more proficiency metrics and possibly other proficiency metrics available to the system.

As another example, a system for providing a score for a spontaneous speech response to a prompt may include one or more data processors and a computer-readable medium encoded with instructions for commanding the one or more data processors to execute a method. In the method, a transcription of the spontaneous speech response may be accessed. A plurality of clauses may be identified within the spontaneous speech response, where identifying a clause includes identifying a beginning boundary and an end boundary of the clause or sentence in the spontaneous speech response. A plurality of disfluencies in the spontaneous speech response may be identified. A plurality of syntactic structures within each clause may be identified. One or more proficiency metrics may be calculated based on the plurality of identified clauses and the identified disfluencies, and the identified syntactic structures. A score for the spontaneous speech response may be generated based on the one or more proficiency metrics.

As a further example, a computer-readable medium may be encoded with instructions for commanding one or more data processors to execute a method for providing a score for a spontaneous speech response to a prompt. In the method, a transcription of the spontaneous speech response may be accessed. A plurality of clauses may be identified within the spontaneous speech response, where identifying a clause includes identifying a beginning boundary and an end boundary of the clause in the spontaneous speech response. A plurality of disfluencies in the spontaneous speech response may be identified. One or more proficiency metrics may be calculated based on the plurality of identified clauses and the identified disfluencies, and a score for the spontaneous speech response may be generated based on the one or more proficiency metrics.

### BRIEF DESCRIPTION OF THE DRAWINGS

FIG. 1 is a block diagram depicting an environment for providing a score for a spontaneous speech response to a prompt.

FIG. 2 is a system diagram performing an overview of operations that may be performed by a speech scoring engine.

FIG. 3 is a block diagram depicting a clause identification operation.

FIG. 4A is a block diagram depicting a disfluency identification operation.

FIG. 4B is a block diagram depicting a syntactic structure identification operation.

FIG. 5 is a chart depicting certain proficiency metrics determined in one experiment to have a strong correlation with manual proficiency scores.

FIG. 6 depicts at a computer-implemented environment wherein users can interact with a speech scoring engine hosted on one or more servers through a network.

FIGS. 7A, 7B, and 7C depict example systems for use in implementing an irregular time period data modeler.

### DETAILED DESCRIPTION

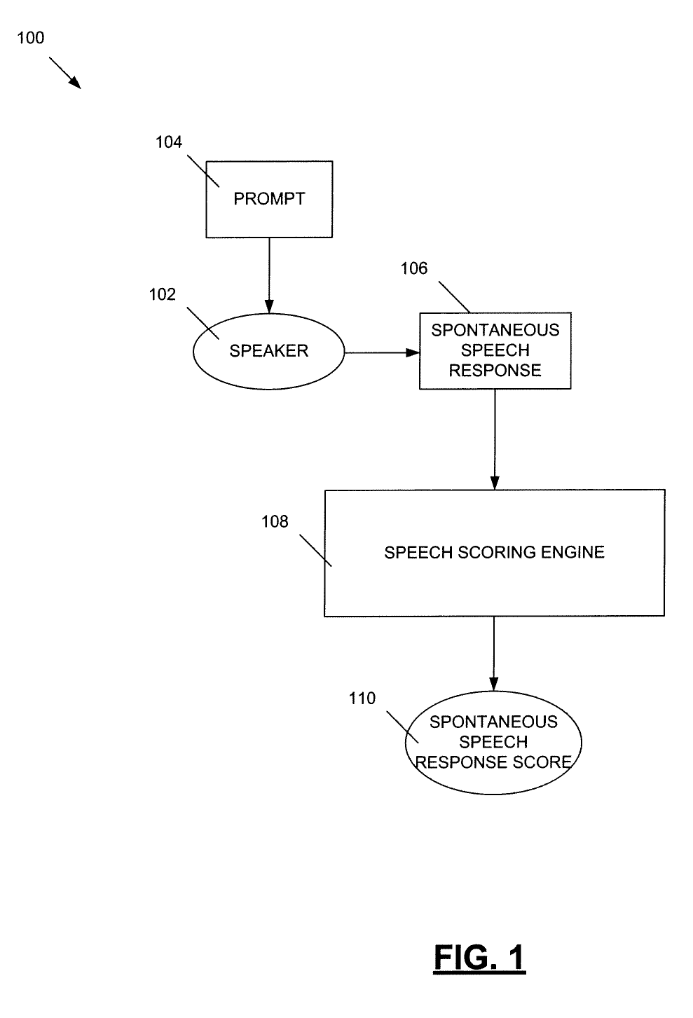

FIG. 1 is a block diagram depicting an environment for providing a score for a spontaneous speech response to a prompt. A speaker 102 is provided a speaking prompt 104. For example, in English as a second language exam, a test taker may be asked to provide information or opinions on familiar topics based on their personal experience or background knowledge. For example, test takers may be asked to describe their opinions on living on campus or off campus. In response to a received prompt 104, the speaker 102 provides a spontaneous speech response 106. The spontaneous speech response 106 may come in a variety of forms such as, a single sentence, a paragraph, or a longer speech unit. The spontaneous speech response 106 may be recorded in a variety of ways. For example, the spontaneous speech response 106 may be captured via an audio recording for later transcription or other processing. The spontaneous speech response 106 may also be transcribed live at the time of speaking. The spontaneous speech response may also be captured via a voice recognition computer program that may use the live spoken response or a recording of the spoken response as an input.

The spontaneous speech response 106 is provided to a speech scoring engine 108. The speech scoring engine 108 analyzes the spontaneous speech response 106 to generate a spontaneous speech response score 110 for the spontaneous speech response 106. For example, the speech scoring engine 108 may identify certain characteristics of the spontaneous speech response 106 and use those characteristics to calculate the score 110.

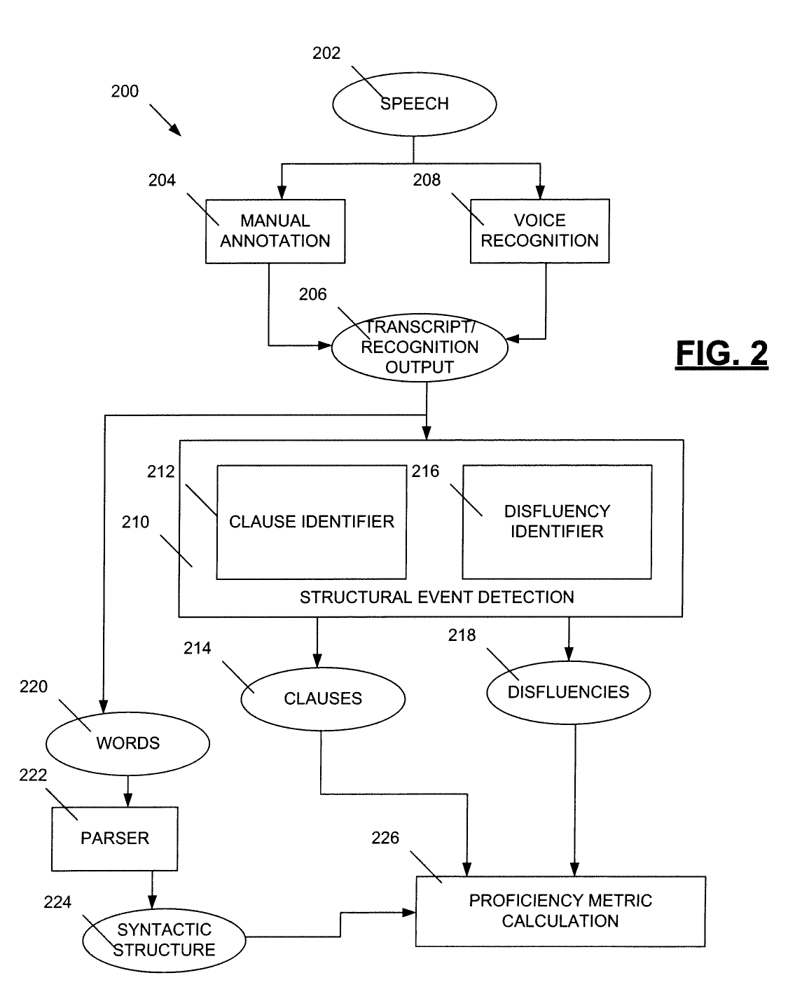

FIG. 2 is a system diagram performing an overview of operations that may be performed by a speech scoring engine. An embodiment of spoken speech 202 is received. For example, such an embodiment could be a recording of speech or a live broadcasting of speech. The received speech 202 may be manually annotated at 204 to generate a transcript 206 or the speech 202 may be analyzed using voice recognition software 208 to generate a recognition output 206. The transcript/recognition output 206 is provided for structural event detection 210. A clause identifier 212 recognizes clauses within the transcript/recognition output 206 and outputs those recognized clauses 214. A disfluency identifier 216 recognizes disfluencies within the transcript/recognition output 206 and outputs those recognized disfluencies 218. The words 220 from the transcript/recognition output 206 may also be provided with a parser 222. The parser 222 analyzes the words 220 to identify a syntactic structure 224 of the words 220. Each of the identified clauses 214, disfluencies 218, and syntactic structure 224 are provided for calculation of one or more proficiency metrics 226.

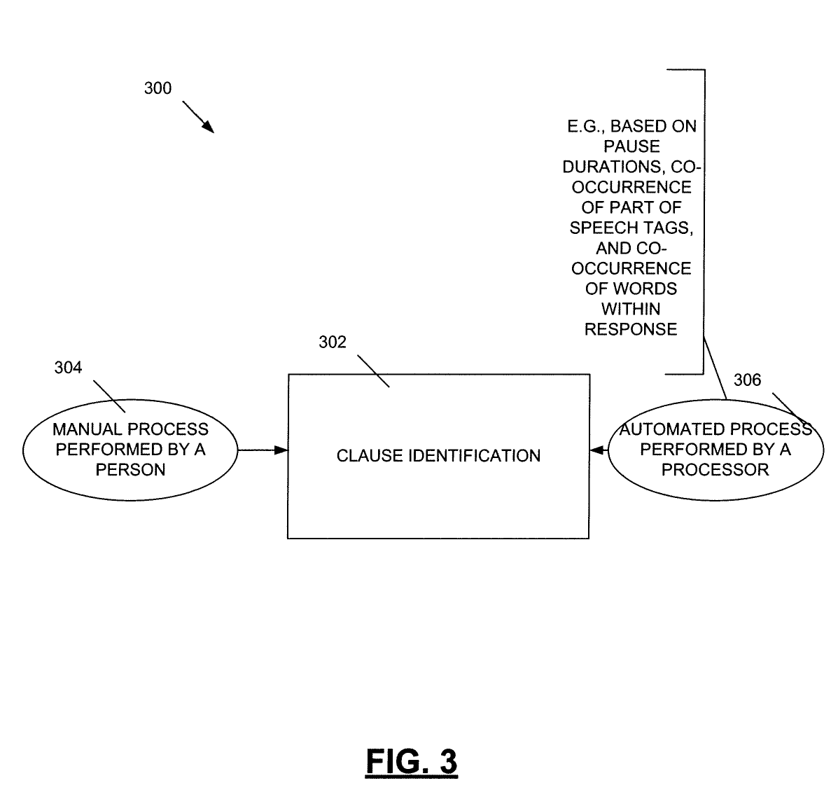

FIG. 3 is a block diagram depicting a clause identification operation. Clause identification 302 may be performed as a partially manual process performed by a person 304. For example, a clause identifier may access a transcription of a spontaneous speech response and annotate the transcription via a keyboard, mouse, or other input. For example, round brackets may be used to indicate the beginning and end of a clause. Abbreviations may be added to the clauses to identify a clause type.

As shown at 306, clauses may also be identified using an automated process performed by a processor. For example, automated clause boundary identification may be performed using a classifier based on lexical and prosodic features around the word boundary. Typical lexical features may include co-occurrence of words or Part of Speech (POS) tags. Typical prosodic features may include the pause duration before the word boundary.

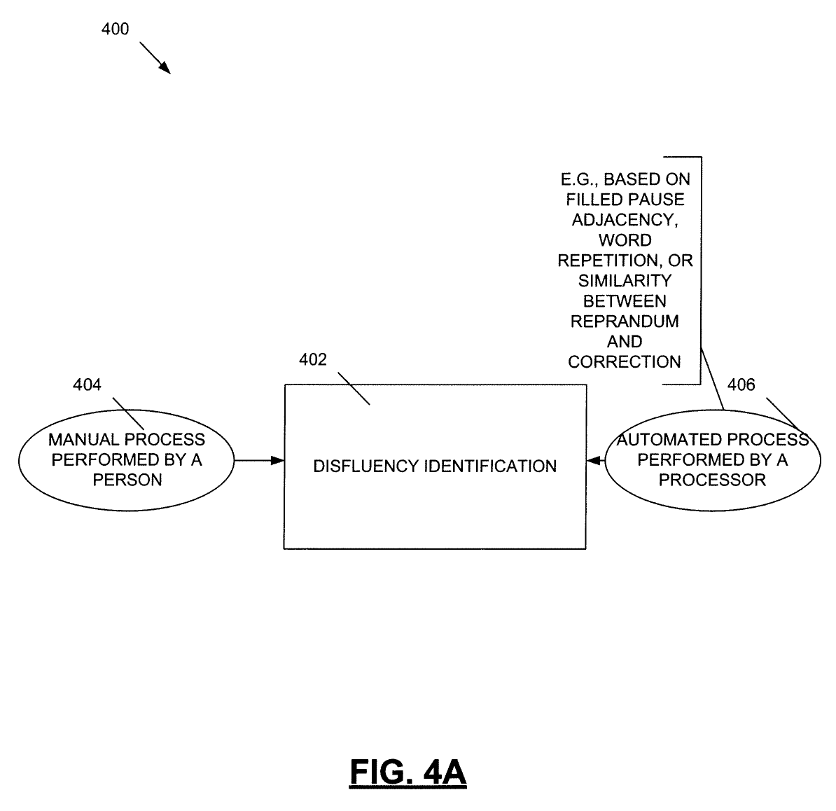

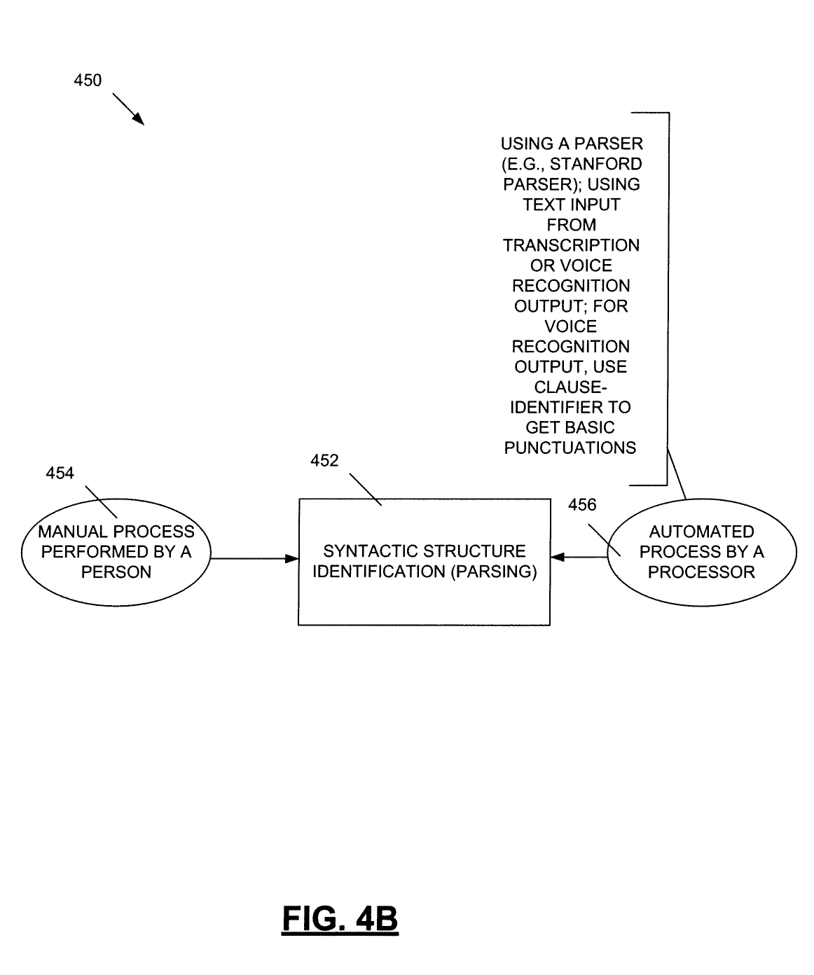

FIG. 4A is a block diagram depicting a disfluency identification operation. Disfluency identification 402 may be performed as a partially manual process performed by a person 404. For example, a disfluency identifier may access a transcription of a spontaneous speech response and annotate the transcription via a keyboard, mouse, or other input. The disfluency identifier may annotate the transcription to identify interruption points in the spontaneous speech response. The disfluency identifier may further identify specific parts of disfluency in the response.

Disfluencies can further be sub-classified into several groups: silent pauses, filled pauses (e.g., uh and um), false starts, repetitions, and repairs. The repetitions and repairs were denoted as “edit disfluency”, which were comprised of a reparandum, an optional editing term, and a correction. The reparandum is the part of an utterance that a speaker wants to repeat or change, while the correction contains the speaker's correction. The editing term can be a filled pause (e.g., um) or an explicit expression (e.g., sorry). The interruption point (IP), occurring at the end of reparandum, is where the fluent speech is interrupted to prepare for the correction. In the following sentence, “He ₁ is ₂ a ₃ very ₄ mad ₅ er ₆ very ₇ bad ₈ police ₉ officer”, IP is 5, reparandum is “very mad”, correction is “very bad”, and editing term is “er”.

As shown at 406, disfluencies may also be identified using an automated process performed by a processor. For example, automated disfluency identification may be performed using a classifier based on lexical features including co-occurrence of words, syntactic features including co-occurrence of Part of Speech (POS) tags, and prosodic features including pause duration, pitch, duration of syllable, or word around the word boundary. The followings are examples of lexical and syntactic features for the classifier.

Word N-gram features: Given wᵢ as the word token at position i, [symbol] wᵢ [symbol] , [symbol] wᵢ₋₁,wᵢ [symbol] , [symbol] wᵢ,wᵢ₊₁ [symbol] , [symbol] wᵢ₋₂,wᵢ₋₁,wᵢ [symbol] , [symbol] wᵢ,wᵢ₊₁,wᵢ₊₂ [symbol] , and [symbol] wᵢ₋₁,wᵢ,wᵢ₊₁ [symbol] .
POS tag N-gram features: Given tᵢ as the POS tag at position i, [symbol] tᵢ [symbol] , [symbol] tᵢ₋₁,tᵢ [symbol] , [symbol] tᵢ,tᵢ₊₁ [symbol] , [symbol] tᵢ₋₂,tᵢ₋₁,tᵢ [symbol] , [symbol] tᵢ,tᵢ₊₁,tᵢ₊₂ [symbol] , and [symbol] tᵢ₋₁,tᵢ,tₜ₊₁ [symbol] .
Filled pause adjacency: This feature has a binary value showing whether a filled pause such as uh or um was adjacent to the current word (wᵢ).
Word repetition: This feature has a binary value showing whether the current word (wᵢ) was repeated in the following 5 words or not.
Similarity: This feature has a continuous value which measures the similarity between reparandum and correction. Assuming that wᵢ was the end of reparandum, the start point and the end point of the reparandum and correction may be estimated, and the string edit distance between reparandum and correction may be calculated. The start point and the end point of the reparandum and correction may be estimated as follows: if wᵢ appeared in the following 5 words, then the second occurrence is defined as the end of the correction. Otherwise, wᵢ+5 may be defined as the end of correction. Secondly, N, the length of the correction may be calculated, and w_{i-N+1} is defined as the start point of the reparandum. During the calculation of the string edit distance, a word fragment may be considered to be the same as a word whose initial character sequences matched.

Automated detection of clause boundaries and disfluencies may be performed using classifier built on conditional models, such as maximum entropy (MaxEnt) model and Conditional Random Fields (CRF) model. Based on a variety of features, the structural event detection task can be generalized as:

\hat{E}=argmax_{E}P(E|W)

Given that E denotes the between-word event sequence and W denotes the corresponding features, the goal is to find the event sequence that has the greatest probability, given the observed features.

FIG. 4B is a block diagram depicting a syntactic structure identification operation. Syntactic structure identification 452 may be performed as a partially manual process performed by a person 454. For example, a syntactic structure identifier may access a transcription of a spontaneous speech response and annotate the transcription via a keyboard, mouse, or other input. The syntactic structure identifier may annotate the transcription to identify syntax elements in the spontaneous speech response.

Syntactic structure identification 452 may also be an automated process performed by a processor 456. For example, the Stanford Parser (an open-source parser software developed by Stanford University) may be utilized. The parser may utilize text input from the transcript of the voice recognition output. If the parser uses the voice recognition output, the parser may further rely on clause identification outputs to identify basic punctuation.

The speech scoring engine may also calculate proficiency metrics based on the identified clauses and disfluencies as shown at 226. These proficiency metrics may be based on structural event annotations, including clause boundaries and their types, disfluencies, as well as identified syntax. Some features measuring syntactic complexity and disfluency profile may also be calculated.

Because simple sentences (SS), independent clauses (I), and conjunct clauses (CC) represent a complete idea, they are considered a T-Unit (T). Clauses that have no complete idea are dependent clauses (DEP), which include noun clauses (N), relative clauses that functions as an adjective (ADJ), adverbial clauses (ADV), and adverbial phrases (ADVP). The total number of clauses is a summation of number of T-units (T), dependent clauses (DEP), and failed clauses (denoted as F). Therefore,

N_{T}=N_{SS}+N_{I}+N_{CC}

N_{DEP}=N_{NC}+N_{ADJ}+N_{ADV}+N_{ADVP}

N_{C}=N_{T}+N_{DEP}+N_{F}

Assuming N_{w} is the total number of words in the speech response (without pruning speech repairs), the following features are derived:

MLC=N_{w}/N_{C}

DEPC=N_{DEP}/N_{C}

IPC=N_{IP}/N_{C}

where MLC is a mean length of clause metric, DEPC is a dependent clause frequency metric, and IPC is an interruption point frequency per clause metric.

Furthermore, the IPC feature may be adjusted. Disfluency may be a complex behavior that is influenced by a variety of factors, such as proficiency level, speaking rate, and familiarity with speaking content. The complexity of utterances is also an important factor on the disfluency pattern. Complexity of expression computed based on the language's parsing tree structure may influence frequency of disfluency. Because disfluency frequency may not only be influenced by test-takers' speaking proficiency but also by speaking content difficulty, the IPC metric can be adjusted accordingly. For this purpose, the IPC can be normalized by dividing some features related to content's complexity, including MLC, DEPC, and both. Thus, the following elaborated disfluency-related features may be calculated:

IPCn1=IPC/MLC

IPCn2=IPC/DEPC

IPCn3=IPC/MLC/DEPC

Syntactic structures are commonly expressed as “parse trees”, i.e., a hierarchical structure of constituents within a sentence. (e.g., the sentence “he gave the book to his little sister” would have the 3 nominal constituents “he”, “the book”, and “his little sister” and a verbal constituent “gave”). Furthermore, in most syntactic descriptions, the phrase “gave the book to his little sister” would be considered a verbal constituent phrase itself, containing the main verb “gave” and the 2 nominal constituents “the book” and “to his little sister”. Finally, the whole sentence would be considered as yet another verbal or sentential constituent, comprising the constituent “he” as a subject and the rest (the “verb phrase”) as a second constituent of the entire sentential phrase.

The identification of syntactic structures as exemplified above is usually performed by either manual annotation by human experts or by automated systems, called syntactic parsers. Based on these identified syntactic structures or constituents, proficiency metrics may be derived, e.g., “frequency of nominal phrases per sentence”.

The speech scoring engine may generate a spontaneous speech response score based on the proficiency metrics. For example, weights may be assigned to certain proficiency metrics. By combining those weights with calculated values for the proficiency metrics, an overall score for the spontaneous speech response may be generated. The overall score for a spoken response may be based totally or in part on features derived from the clause structures, disfluencies, and syntactic structures explicated above. In order to compute a score for a response, other features such as features related to pronunciation or other aspects of speech, may also be used together with the features mentioned in this application.

Certain proficiency metrics may be more highly correlated with high quality spontaneous speech responses than others. Such correlations may be determined by performing a manual (e.g., human) or other scoring of a spontaneous speech responses. Proficiency metrics for the spontaneous speech responses may be calculated, and correlations between the proficiency metrics and the manual scores may be determined to determine which proficiency metrics have the best correlation with the scores. Based on the determined correlation determinations, proficiency metrics may be selected, and a model may be generated based on those proficiency metrics to score spontaneous speech responses (e.g., a regression analysis may be performed using the scores and selected proficiency metrics to determine proficiency metric weights for use in scoring spontaneous speech responses).

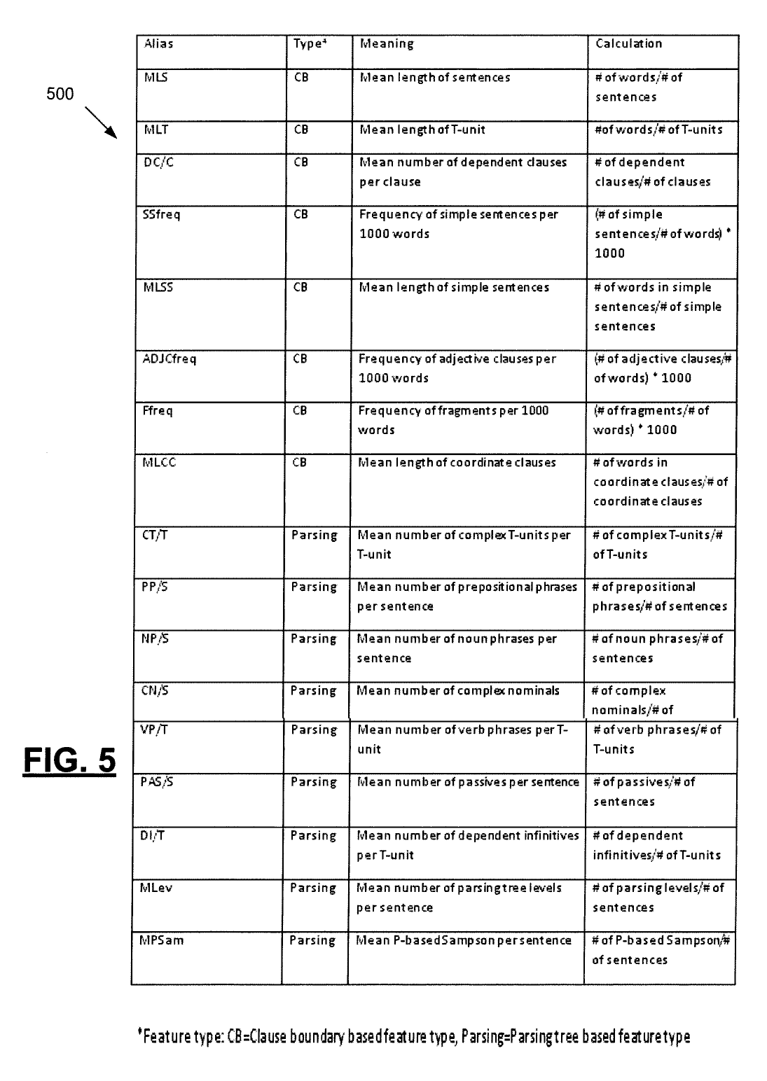

FIG. 5 is a chart depicting certain proficiency metrics determined in one experiment to have a strong correlation with manual proficiency scores. A set of 80 candidate proficiency metrics were identified. The candidate proficiency metrics were calculated for each of 760 spontaneous speech responses. The spontaneous speech responses were also given a manual score by a trained response rater. Correlations between the manual scores and the candidate proficiency metrics were calculated, and a set of proficiency metrics were selected. These proficiency metrics were selected from candidate proficiency metrics of boundary based and parse tree based feature types. The selected boundary based proficiency metrics were mean length of sentences, mean length of T-unit, mean number of dependent clauses per clause, frequency of simple sentences, mean length of simple sentences, frequency of adjective clauses, frequency of fragments, and mean length of coordinate clauses. The selected parse tree based proficiency metrics were mean number of complex T-units, mean number of prepositional phrases per sentence, mean number of noun phrases per sentence, mean number of complex nominals, mean number of verb phrases per T-unit, mean number of passives per sentence, mean number of dependent infinitives per T-unit, mean number of parsing tree levels per sentence, mean P-based Sampson per sentence.

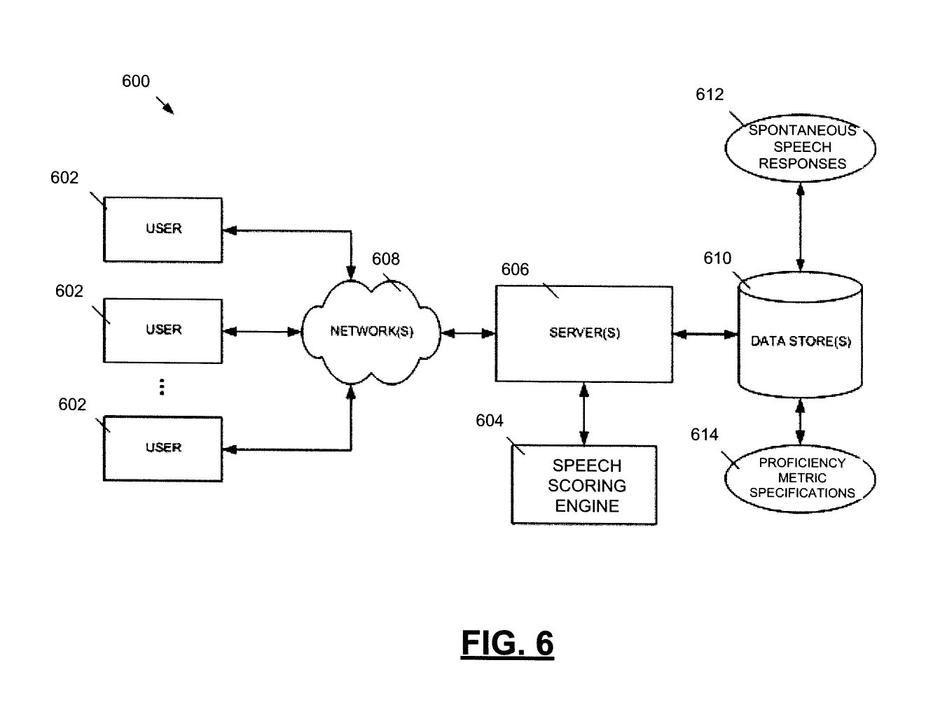

FIG. 6 depicts at 600 a computer-implemented environment wherein users 602 can interact with a speech scoring engine 604 hosted on one or more servers 606 through a network 608. The system 604 contains software operations or routines for providing a score for a spontaneous speech response to a prompt. The users 602 can interact with the system 604 through a number of ways, such as over one or more networks 608. One or more servers 606 accessible through the network(s) 608 can host the speech scoring engine 604. It should be understood that the speech scoring engine 604 could also be provided on a stand-alone computer for access by a user.

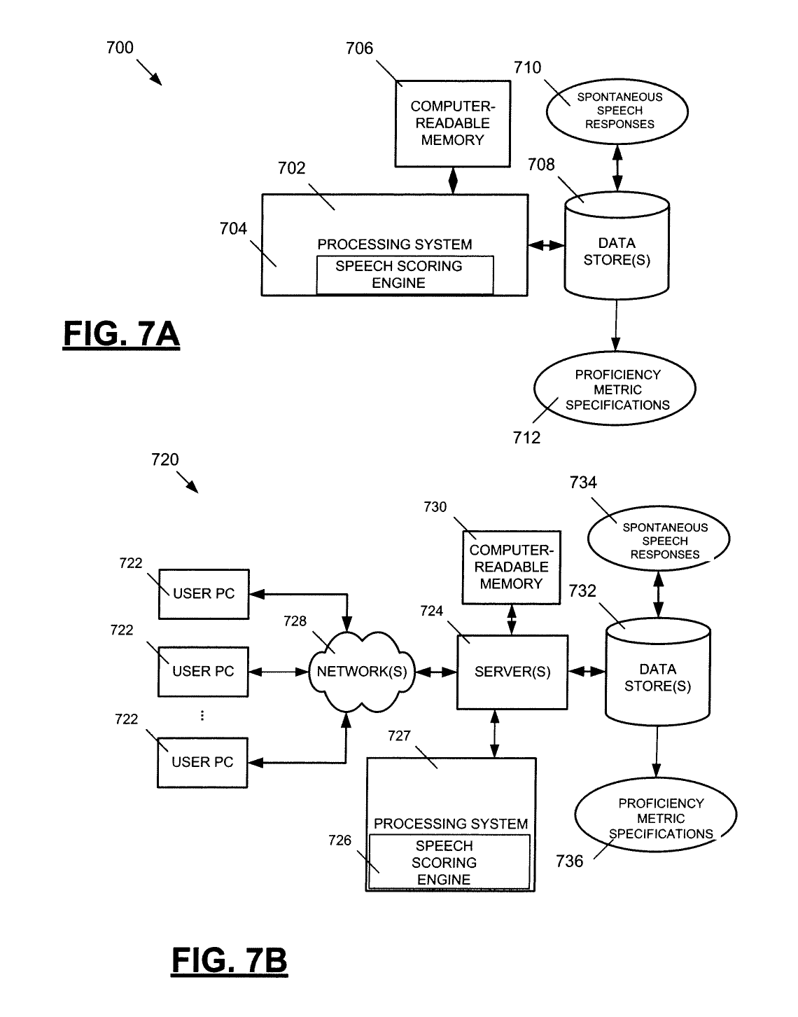

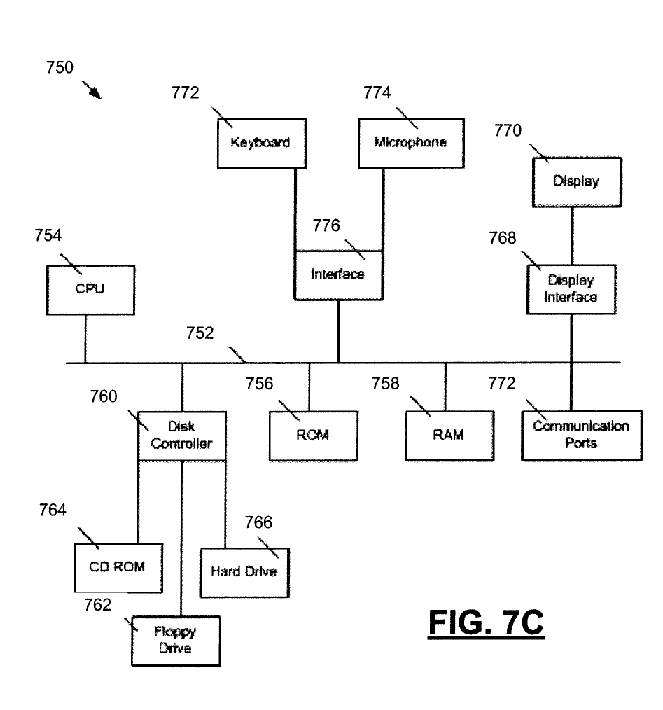

FIGS. 7A, 7B, and 7C depict example systems for use in implementing a speech scoring engine. For example, FIG. 7A depicts an exemplary system 700 that includes a standalone computer architecture where a processing system 702 (e.g., one or more computer processors) includes a speech scoring engine 704 being executed on it. The processing system 702 has access to a computer-readable memory 706 in addition to one or more data stores 708. The one or more data stores 708 may contain spontaneous speech responses 710 (e.g., transcriptions or audio recordings) as well as proficiency metric specifications 712.

FIG. 7B depicts a system 720 that includes a client server architecture. One or more user PCs 722 accesses one or more servers 724 running a speech scoring engine 726 on a processing system 727 via one or more networks 728. The one or more servers 724 may access a computer readable memory 730 as well as one or more data stores 732. The one or more data stores 732 may contain spontaneous speech responses 734 as well as proficiency metric specifications 736.

FIG. 7C shows a block diagram of exemplary hardware for a standalone computer architecture 750, such as the architecture depicted in FIG. 7A that may be used to contain and/or implement the program instructions of system embodiments of the present invention. A bus 752 may serve as the information highway interconnecting the other illustrated components of the hardware. A processing system 754 labeled CPU (central processing unit) (e.g., one or more computer processors), may perform calculations and logic operations required to execute a program. A processor-readable storage medium, such as read only memory (ROM) 756 and random access memory (RAM) 758, may be in communication with the processing system 754 and may contain one or more programming instructions for performing the method of implementing a speech scoring engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 760 interfaces one or more optional disk drives to the system bus 752. These disk drives may be external or internal floppy disk drives such as 762, external or internal CD-ROM, CD-R, CD-RW or DVD drives such as 764, or external or internal hard drives 766. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 760, the ROM 756 and/or the RAM 758. Preferably, the processor 754 may access each component as required.

A display interface 768 may permit information from the bus 756 to be displayed on a display 770 in audio, graphic, or alphanumeric format. Communication with external devices may optionally occur using various communication ports 772.

In addition to the standard computer-type components, the hardware may also include data input devices, such as a keyboard 772, or other input device 774, such as a microphone, remote control, pointer, mouse and/or joystick.

This written description uses examples to disclose the invention, including the best mode, and also to enable a person skilled in the art to make and use the invention. The patentable scope of the invention may include other examples. For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of providing a score for a spontaneous non-native speech response to a prompt, comprising:
accessing a transcription of the spontaneous speech response;
identifying structural events within the spontaneous speech response, said identifying comprising:
identifying a plurality of clauses within the spontaneous speech response, wherein identifying a clause includes identifying a beginning boundary and an end boundary of the clause in the spontaneous speech response, and
identifying a plurality of disfluencies in the spontaneous speech response;
calculating one or more proficiency metrics based on the identified clauses and identified disfluencies; and
generating a score for the spontaneous speech response based on the one or more proficiency metrics;
wherein said accessing, identifying a plurality of clauses, identifying a plurality of disfluencies, calculating, and generating are performed using one or more data processors.

2. The computer-implemented method of claim 1, wherein the transcription is machine generated or human generated.

3. The computer-implemented method of claim 1, where one of the plurality of clauses is a sentence and one of the plurality of clauses is a T-unit.

4. The computer-implemented method of claim 1, wherein identifying a clause includes associating a clause type with the clause.

5. The computer-implemented method of claim 4, wherein the clause type is selected from the group consisting of: a simple sentence, an independent clause, a noun clause, an adjective clause, an adverbial clause, a coordinate clause, and an adverbial phrase.

6. The computer-implemented method of claim 1, wherein identifying a disfluency includes identifying an interruption point.

7. The computer-implemented method of claim 1, wherein identifying a disfluency includes identifying a reparandum, an editing phrase, and a correction.

8. The computer-implemented method of claim 1, wherein the one or more proficiency metrics includes a mean length of clause metric based on a number of words in the spontaneous speech response and a total number of clauses in the spontaneous speech response.

9. The computer-implemented method of claim 1, wherein the one or more proficiency metrics includes a dependent clause frequency metric based on a number of dependent clauses in the spontaneous speech response and a total number of clauses in the spontaneous speech response.

10. The computer-implemented method of claim 1, wherein the one or more proficiency metrics includes an interruption point frequency per clause metric based on a number of interruption points in the spontaneous speech response and a total number of clauses in the spontaneous speech response.

11. The computer-implemented method of claim 1, wherein the one or more proficiency metrics includes an adjusted interruption point frequency per clause metric based on an interruption point frequency per clause metric and a mean length of clause metric.

12. The computer-implemented method of claim 1, wherein the one or more proficiency metrics includes an adjusted interruption point frequency per clause metric based on an interruption point frequency per clause metric and a dependent clause frequency metric.

13. The computer-implemented method of claim 1, wherein the one or more proficiency metrics includes an adjusted interruption point frequency per clause metric based on an interruption point frequency per clause metric, a mean length of clause metric, and a dependent clause frequency metric.

14. The computer-implemented method of claim 1, wherein the identifying a plurality of clauses within the spontaneous speech response is performed by a person.

15. The computer-implemented method of claim 1, wherein the identifying a plurality of clauses within the spontaneous speech response is performed automatically by a processor.

16. The computer-implemented method of claim 15, wherein a clause is identified based on a subset or all from a group of lexical, syntactic, and prosodic features within the spontaneous speech response.

17. The computer-implemented method of claim 1, wherein the identifying a plurality of disfluencies within the spontaneous speech response is performed automatically by a processor.

18. The computer-implemented method of claim 1, wherein the plurality of disfluencies in the spontaneous speech response are identified automatically by a processor based on a subset or all from a group of lexical, syntactic, or prosodic features, a filled pause adjacency, a word repetition, or a similarity between a candidate reparandum and a candidate correction.

19. The computer-implemented method of claim 1, wherein the plurality of disfluencies in the spontaneous speech response are manually identified.

20. The computer-implemented method of claim 1, wherein the score is based on one or more proficiency metrics based on information obtained from a syntactic parser.

21. The computer-implemented method of claim 20, wherein the syntactic parser identifies one or more of mean length of sentences, mean length of T-unit, mean number of dependent clauses per clause, frequency of simple sentences, mean length of simple sentences, frequency of adjective clauses, frequency of fragments, mean length of coordinate clauses; mean number of complex T-units, mean number of prepositional phrases per sentence, mean number of noun phrases per sentence, mean number of complex nominals, mean number of verb phrases per T-unit, mean number of passives per sentence, mean number of dependent infinitives per T-unit, mean number of parsing tree levels per sentence, and mean P-based Sampson per sentence.

22. The computer-implemented method of claim 21, wherein the score of a spontaneous speech response is based on one or more proficiency metrics selected from the list in claim 20.

23. A computer-implemented system for providing a score for a spontaneous non-native speech response to a prompt, comprising:
one or more data processors;
a computer-readable medium encoded with instructions for commanding the one or more data processors to execute steps including:
accessing a transcription of the spontaneous speech response;
identifying structural events within the spontaneous speech response, said identifying comprising:
identifying a plurality of clauses within the spontaneous speech response, wherein identifying a clause includes identifying a beginning boundary and an end boundary of the clause in the spontaneous speech response, and
identifying a plurality of disfluencies in the spontaneous speech response;
calculating one or more proficiency metrics based on the identified clauses and identified disfluencies; and
generating a score for the spontaneous speech response based on the one or more proficiency metrics.

24. A computer-readable medium encoded with instructions for commanding one or more data processors to execute a method for providing a score for a spontaneous non-native speech response to a prompt, the method comprising:
accessing a transcription of the spontaneous speech response;
identifying structural events within the spontaneous speech response, said identifying comprising:
identifying a plurality of clauses within the spontaneous speech response, wherein identifying a clause includes identifying a beginning boundary and an end boundary of the clause in the spontaneous speech response, and
identifying a plurality of disfluencies in the spontaneous speech response;
calculating one or more proficiency metrics based on the identified clauses and identified disfluencies; and
generating a score for the spontaneous speech response based on the one or more proficiency metrics;
wherein said accessing, identifying a plurality of clauses, identifying a plurality of disfluencies, calculating, and generating are performed using one or more data processors.
